(19) United States
(12) Patent Application Publication
(10) Pub. No.: US 2016/0026614 A1
(43) Pub. Date: Jan. 28, 2016

(54) METHODS AND APPARATUS FOR ANNOTATING DOCUMENTS

(71) Applicant: kCura Corporation, Chicago, IL (US)

(72) Inventors: David Bireta, Evanston, IL (US); Casey Bubert, Chicago, IL (US); Laura M. Lanford, Chicago, IL (US); Bryan D. Oakley, Barrington, IL (US); Kevin R. Forshey, Chicago, IL (US)

(21) Appl. No.: 14/340,260

(22) Filed: Jul. 24, 2014

(51) Int. Cl. G06F 17/24; H04L 29/08; G06F 17/30

(52) U.S. Cl. CPC G06F 17/241; G06F 17/30575; H04L 67/10; G06F 17/30864; G06F 17/30011

(57) ABSTRACT

Methods and apparatus for annotating documents are disclosed. For example, a user of an electronic record management system may be viewing a document and/or metadata associated with a document offline, such as on a tablet device that does not necessarily have network connectivity. Prior to losing network connectivity, a saved search associated with a user profile is executed to retrieve a subset of documents. The subset of documents and associated metadata are then automatically downloaded to the portable electronic device. Subsequently, even if the device loses network connectivity (e.g., the user is on an airplane), the user may annotate documents. After network connectivity is restored, the documents and the annotated version of the documents are automatically synchronized, which may include merging the user's annotations with other user's annotations.

The present disclosure relates in general to databases, and, in particular, to methods and apparatus for annotating documents.

### BACKGROUND

The vast majority of documents we create and/or archive are stored electronically. In order to quickly find certain documents, the relevant data from these documents is typically extracted, catalogued, and organized in a centralized database to make them searchable. Once the documents are in the database, certain documents are typically annotated. For example, in a lawsuit, certain portions of some documents may be highlighted and or commented by a reviewer. In some circumstances, these databases can be very large. For example, a law suit may involve millions of documents. Coding documents in these large databases can be problematic.

Typically, users review and annotate the documents on a computing device while the computing device is connected to the database via a network connection. For example, the user may view a document using a desktop computing device and redact a certain portion of text. Subsequently, the user's annotations are stored back to the central database. In this manner, other users can also see the annotations.

Often, users work on portable computing devices that are sometimes not connected to a network. For example, an attorney may want to review and annotate documents during a flight using a tablet device. However, doing so suffers from several drawbacks. First, due to memory limitations of the portable computing device, the entire database and associated documents typically cannot be copied to the portable computing device. As a result, the user is forced to find a subset of documents and manually move them over to the portable electronic device.

In addition, the central database will need to be manually updated to include any annotations made by the user to the selected subset of documents. This is especially problematic if other users have annotated the same document during that same time period.

### BRIEF DESCRIPTION OF THE DRAWINGS

FIG. 1 is a block diagram of an example network communication system.

FIG. 2 is a block diagram of an example computing device.

FIG. 3 is a flowchart of an example process for annotating documents.

FIG. 4 is a screen shot of an example document annotation application.

### DETAILED DESCRIPTION OF THE PREFERRED EMBODIMENTS

Briefly, methods and apparatus for annotating documents are disclosed. For example, a user of an electronic record management system may be viewing a document and/or metadata associated with a document offline, such as on a tablet device that does not necessarily have network connectivity. Prior to losing network connectivity, a saved search associated with a user profile is executed to retrieve a subset of documents. The subset of documents and associated metadata are then automatically downloaded to the portable electronic device. Subsequently, even if the device loses network connectivity (e.g., the user is on an airplane), the user may annotate documents. After network connectivity is restored, the documents and the annotated version of the documents are automatically synchronized, which may include merging the user's annotations with other users' annotations.

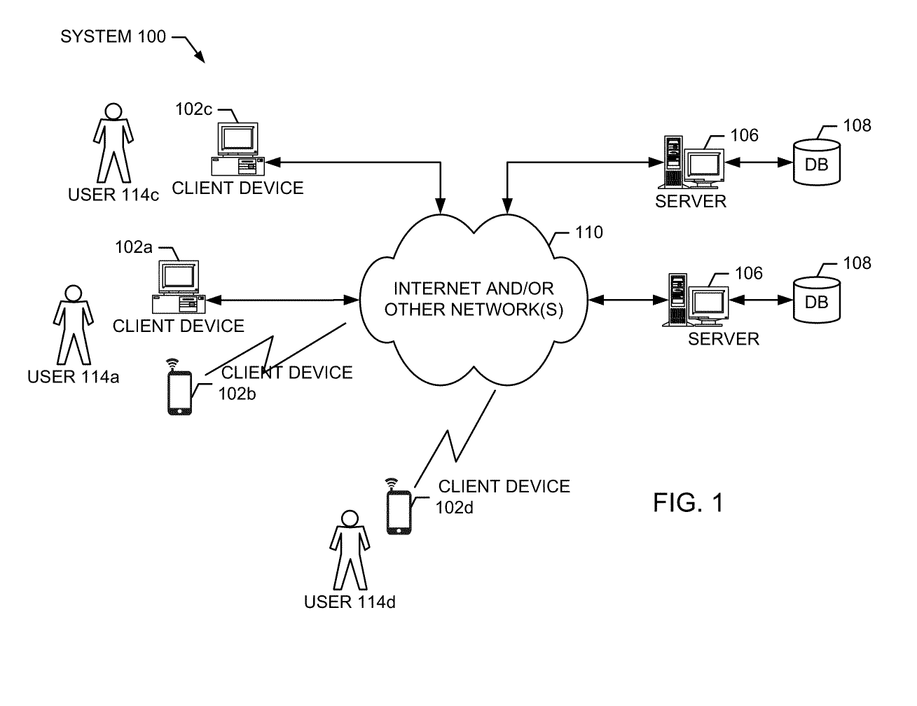

Turning now to the figures, the present system is most readily realized in a network communication system 100. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

In this example, user 114a is using client device 102a and client device 102b. For example, user 114a may be reviewing documents displayed on a desktop display of client device 102a and coding those documents using a touch screen on client device 102b.

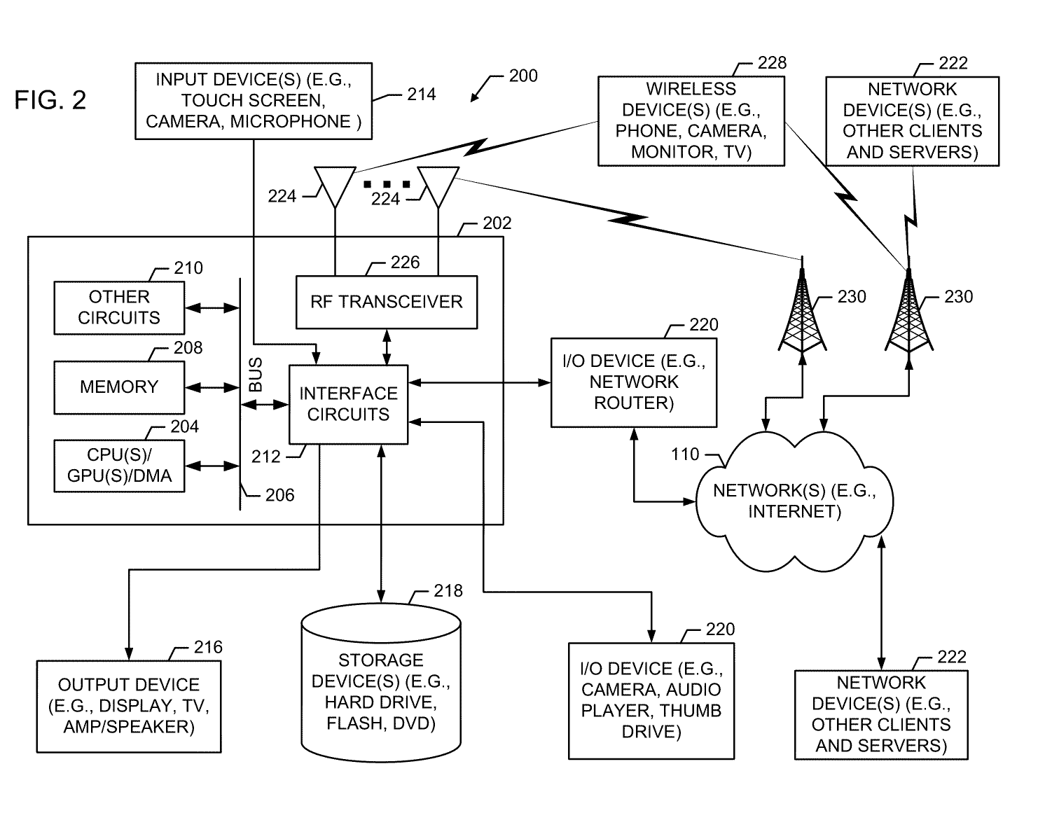

Each of the devices illustrated in FIG. 1 (e.g., clients 102 and/or servers 106) may include certain common aspects of many computing devices such as microprocessors, memories, input devices, output devices, etc. FIG. 2 is a block diagram of an example computing device. The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200. The computing device 200 may also exchange data with one or more input/output (I/O) devices 220, such as network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

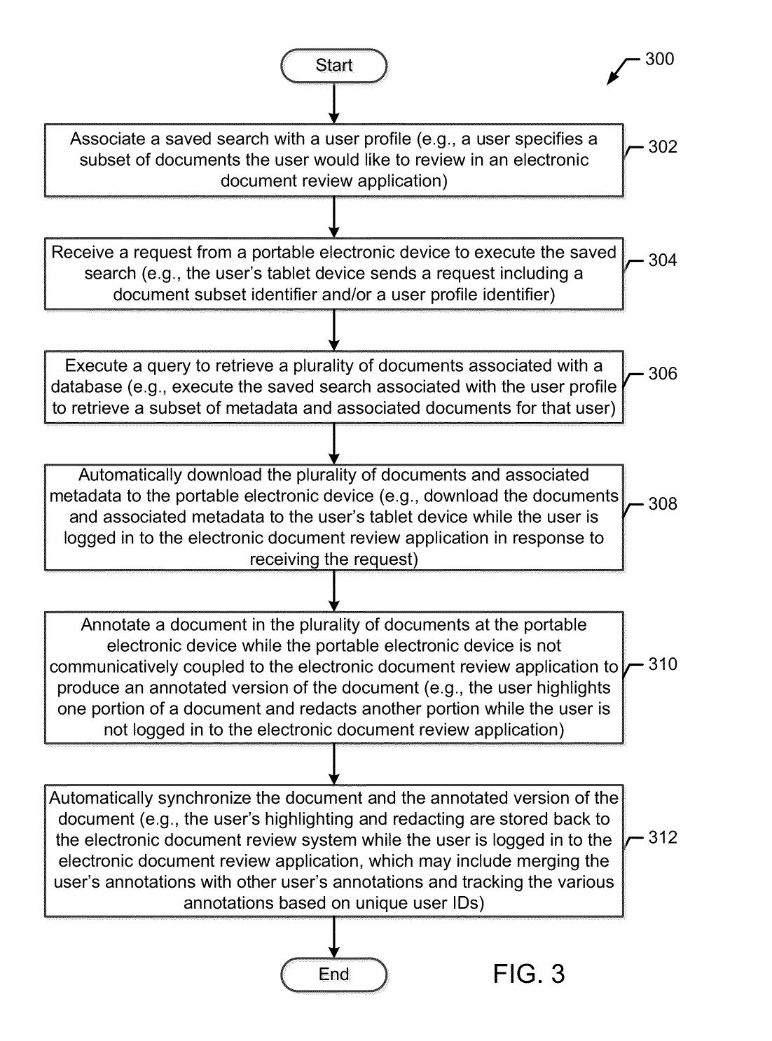

FIG. 3 is a flowchart of an example process for a annotating documents. The process 300 may be carried out by one or more suitably programmed processors, such as a CPU executing software (e.g., block 204 of FIG. 2). The process 300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 300 is described with reference to the flowchart illustrated in FIG. 3, it will be appreciated that many other methods of performing the acts associated with process 300 may be used. For example, the order of many of the operations may be changed, and some of the operations described may be optional.

In this example, the process 300 begins when a saved search is associated with a user profile (block 302). For example, a user may specify a subset of documents the user would like to review in an electronic document review application. Subsequently, a request is received from a portable electronic device to execute the saved search (block 304). For example, the user's tablet device may send a request including a document subset identifier and/or a user profile identifier.

The database query is then executed to retrieve a plurality of documents (block 306). For example, the document review application may execute the saved search associated with the user profile to retrieve a subset of metadata and associated documents for that user. The plurality of documents and associated metadata are then automatically downloaded to the portable electronic device (block 308). For example, the documents and associated metadata may be downloaded to the user's tablet device while the user is logged in to the electronic document review application in response to receiving the request from the portable electronic device.

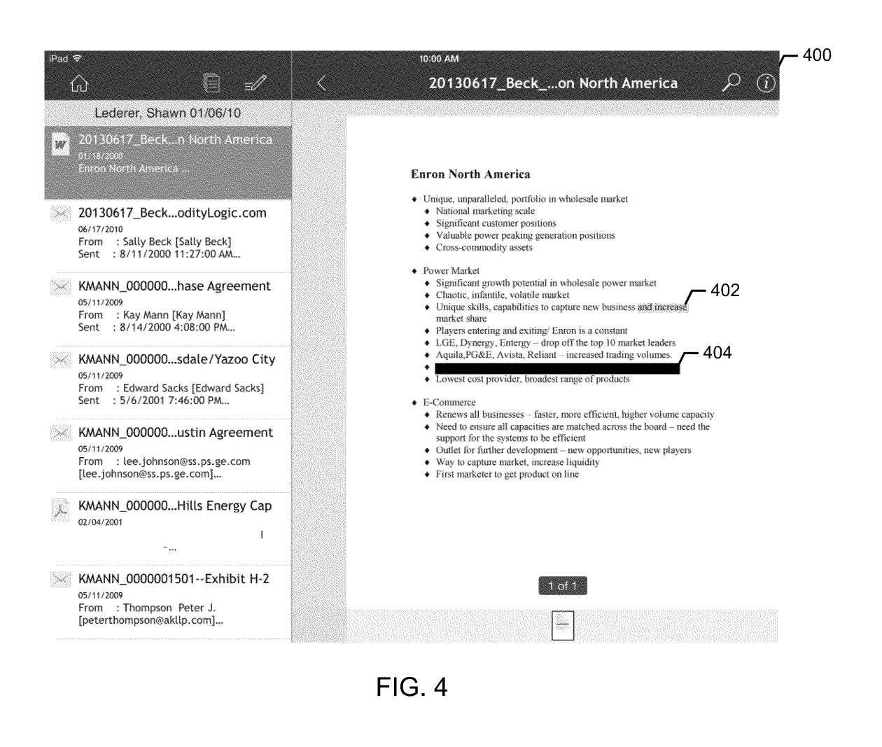

The user may then annotate one or more of the documents in the plurality of documents at the portable electronic device while the portable electronic device is not communicatively coupled to the electronic document review application to produce an annotated version of the document (block 310). For example, the user may highlight one portion of a document and redact another portion of the document while the user is not logged in to the electronic document review application (See FIG. 4).

The document and the annotated version of the document are later automatically synchronized (block 312). For example, the user's highlighting and redacting are stored back to the electronic document review system while the user is logged in to the electronic document review application, which may include merging the user's annotations with other user's annotations and tracking the various annotations based on unique user IDs.

FIG. 4 is a screen shot of an example annotated document 400. In this example, one portion 402 of the document 400 is highlighted, and another portion 404 of the document 400 is redacted. Although annotating documents in an electronic document review application is used as the primary example though out this description, a person of ordinary skill in the art will readily appreciate that the methods and apparatus disclosed herein may be used for any suitable purpose.

In summary, persons of ordinary skill in the art will readily appreciate that methods and apparatus for annotating documents have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of annotating documents associated with an electronic document review application, the method comprising:
executing a query to retrieve a plurality of documents associated with the electronic document review application;
downloading the plurality of documents and associated metadata to a portable electronic device;
annotating a document in the plurality of documents at the portable electronic device while the portable electronic device is not communicatively coupled to the electronic document review application to produce an annotated version of the document; and
automatically synchronizing the document and the annotated version of the document using the electronic document review application.

2. The method of claim 1, further comprising assigning a subset identifier to the plurality of documents and associating the subset identifier with a user profile.

3. The method of claim 1, further comprising assigning a subset identifier to the plurality of documents and associating the subset identifier with a device identifier of the portable electronic device.

4. The method of claim 1, wherein executing the query to retrieve the plurality of documents includes executing a saved search associated with a user profile.

5. The method of claim 1, wherein executing the query to retrieve the plurality of documents is in response to receiving a request from the portable electronic device, the request including the subset identifier.

6. The method of claim 1, wherein executing the query to retrieve the plurality of documents is performed by an electronic document review application.

7. The method of claim 1, wherein synchronizing the document and the annotated version of the document includes merging new annotation data with an existing annotation data.

8. An apparatus for annotating documents associated with an electronic document review application, the apparatus comprising:
a processor;
a network interface operatively coupled to the processor; and
a memory device operatively coupled to the processor, the memory device storing instructions to cause the processor to:
execute a query to retrieve a plurality of documents associated with the electronic document review application;
download the plurality of documents and associated metadata to a portable electronic device;
annotate a document in the plurality of documents at the portable electronic device while the portable electronic device is not communicatively coupled to the electronic document review application to produce an annotated version of the document; and
automatically synchronize the document and the annotated version of the document using the electronic document review application.

9. The apparatus of claim 8, further comprising wherein the instructions are structured to cause the processor to assign a subset identifier to the plurality of documents and associate the subset identifier with a user profile.

10. The apparatus of claim 8, wherein the instructions are structured to cause the processor to assign a subset identifier to the plurality of documents and associate the subset identifier with a device identifier of the portable electronic device.

11. The apparatus of claim 8, wherein executing the query to retrieve the plurality of documents includes executing a saved search associated with a user profile.

12. The apparatus of claim 8, wherein executing the query to retrieve the plurality of documents is in response to receiving a request from the portable electronic device, the request including the subset identifier.

13. The apparatus of claim 8, wherein executing the query to retrieve the plurality of documents is performed by an electronic document review application.

14. The apparatus of claim 8, wherein synchronizing the document and the annotated version of the document includes merging new annotation data with an existing annotation data.

15. A non-transitory computer readable medium storing instructions structured to cause a computing device to:
execute a query to retrieve a plurality of documents associated with the electronic document review application;
download the plurality of documents and associated metadata to a portable electronic device;
annotate a document in the plurality of documents at the portable electronic device while the portable electronic device is not communicatively coupled to the electronic document review application to produce an annotated version of the document; and
automatically synchronizing the document and the annotated version of the document using the electronic document review application.

16. The computer readable medium of claim 15, further comprising wherein the instructions are structured to cause the processor to assign a subset identifier to the plurality of documents and associate the subset identifier with a user profile.

17. The computer readable medium of claim 15, wherein the instructions are structured to cause the processor to assign a subset identifier to the plurality of documents and associate the subset identifier with a device identifier of the portable electronic device.

18. The computer readable medium of claim 15, wherein executing the query to retrieve the plurality of documents includes executing a saved search associated with a user profile.

19. The computer readable medium of claim 15, wherein executing the query to retrieve the plurality of documents is in response to receiving a request from the portable electronic device, the request including the subset identifier.

20. The computer readable medium of claim 15, wherein executing the query to retrieve the plurality of documents is performed by an electronic document review application.

21. The computer readable medium of claim 15, wherein synchronizing the document and the annotated version of the document includes merging new annotation data with an existing annotation data.
